(19) United States
(12) Patent Application Publication
(10) Pub. No.: US 2024/0169420 A1
(43) Pub. Date: May 23, 2024

(54) Server and Lease Fee Calculation Method

(71) Applicant: TOYOTA JIDOSHA KABUSHIKI KAISHA, Toyota-shi (JP)

(72) Inventors: Yasuhide KURIMOTO, Kasugai-shi (JP); Tomoyoshi UEKI, Toyota-shi, Aichi-ken (JP); Yuko TERASAWA, Tokyo-to (JP); Masahiro KAGAMI, Nagoya-shi (JP); Hiroshi YAMASAKI, Nagoya-shi (JP); Kenji ZAITSU, Nisshin-shi (JP); Yoshihiko ENDO, Tokyo-to (JP)

(21) Appl. No.: 18/492,102

(22) Filed: Oct. 23, 2023

(30) Foreign Application Priority Data
Nov. 17, 2022 (JP) 2022-184240

(51) Int. Cl. G06Q 30/0645

(52) U.S. Cl. CPC G06Q 30/0645

(57) ABSTRACT

A server includes: a communication unit (acquisition unit) that acquires information of a capacity retention (degree of degradation) of a battery (secondary battery); and a processor (control unit) that calculates a lease fee of the battery using the information of the capacity retention. The processor performs suppression processing for suppressing an increase of the lease fee, the increase of the lease fee being based on deterioration (decrease) of the capacity retention due to an environment in which the electrically powered vehicle is used.

This nonprovisional application is based on Japanese Patent Application No. 2022-184240 filed on Nov. 17, 2022 with the Japan Patent Office, the entire contents of which are hereby incorporated by reference.

### BACKGROUND

### Field

The present disclosure relates to a server and a lease fee calculation method.

### Description of the Background Art

Japanese Patent Application Laid-Open No. 2018-029430 discloses that a data center receives information about a secondary battery from an electrically powered vehicle and calculates a degree of degradation of the secondary battery.

### SUMMARY

Here, when the secondary battery is a leased secondary battery, the lease fee is set based on the degree of degradation of the secondary battery. In this case, when the electrically powered vehicle is usually used in an environment in which deterioration of the secondary battery is likely to proceed, the secondary battery is deteriorated more than that in a normal case. As a result, the lease fee of the secondary battery becomes higher than that in the normal case. Therefore, it is has been desired to suppress the lease fee of the secondary battery from being increased due to the environment in which the electrically powered vehicle is used.

The present disclosure has been made to solve the problem, and has an object to provide a server and a lease fee calculation method so as to suppress a lease fee of a secondary battery from being increased due to an environment in which an electrically powered vehicle is used.

A server according to a first aspect of the present disclosure is a server that calculates a lease fee of a secondary battery leased to an electrically powered vehicle, the server including: an acquisition unit that acquires information of a degree of degradation of the secondary battery; and a control unit that calculates the lease fee using the information of the degree of degradation. The control unit performs suppression processing for suppressing an increase of the lease fee, the increase of the lease fee being based on deterioration of the degree of degradation due to an environment in which the electrically powered vehicle is used.

In the server according to the first aspect of the present disclosure, as described above, the suppression processing is performed to suppress the increase of the lease fee, the increase of the lease fee being based on the deterioration of the degree of degradation due to the environment in which the electrically powered vehicle is used. Thus, even when the electrically powered vehicle is used in an environment in which the degree of degradation of the secondary battery is likely to be high, the lease fee of the secondary battery is suppressed from being increased. As a result, it is possible to suppress increased lease fee of the secondary battery. Thus, the lease fee of the secondary battery can be suppressed from being increased due to the environment in which the electrically powered vehicle is used.

In the server according to the first aspect, preferably, the control unit performs the suppression processing by adjusting, in accordance with the environment, a correction coefficient for correcting the lease fee. By configuring in this way, the lease fee can be appropriately adjusted in accordance with an environment difference by adjusting the correction coefficient.

In the server according to the first aspect, preferably, the control unit performs the suppression processing by calculating the lease fee while ignoring the deterioration of the degree of degradation due to the environment. By configuring in this way, the lease fee can be prevented from being increased by the deterioration of the degree of degradation due to the environment.

In the server according to the first aspect, preferably, the control unit performs the suppression processing when it is determined that the electrically powered vehicle is usually used in a cold area. By configuring in this way, the lease fee can be suppressed from being increased even when the battery is deteriorated due to a temperature in the cold area.

A lease fee calculation method according to a second aspect of the present disclosure is a lease fee calculation method for calculating a lease fee of a secondary battery leased to an electrically powered vehicle, the lease fee calculation method including: acquiring information of a degree of degradation of the secondary battery; and calculating the lease fee using the information of the degree of degradation. The calculating includes suppressing an increase of the lease fee, the increase of the lease fee being based on deterioration of an environment in which the electrically powered vehicle is used.

In the lease fee calculation method according to the second aspect of the present disclosure, as described above, the suppression processing is performed to suppress the increase of the lease fee, the increase of the lease fee being based on the deterioration of the degree of degradation due to the environment in which the electrically powered vehicle is used. Thus, it is possible to provide the lease fee calculation method so as to suppress the lease fee of the secondary battery from being increased due to the environment in which the electrically powered vehicle is used.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a system according to a first embodiment.

FIG. 2 is a diagram showing a relationship between a capacity retention of a battery and a lease fee according to the first embodiment.

FIG. 3 is a diagram showing whether each region is cold, warm, or ordinary-temperature.

FIG. 4 is a diagram showing sequence control of the system according to the first embodiment.

FIG. 5 is a diagram showing a configuration of a system according to a second embodiment.

FIG. 6 is a graph showing a decrease in the capacity retention of the battery due to the environment.

FIG. 7 is a diagram showing sequence control of the system according to the second embodiment.

### DESCRIPTION OF THE PREFERRED EMBODIMENTS

### First Embodiment

Hereinafter, a first embodiment of the present disclosure will be described in detail with reference to the drawings. In the drawings, the same or corresponding parts are denoted by the same reference numerals, and the description thereof will not be repeated.

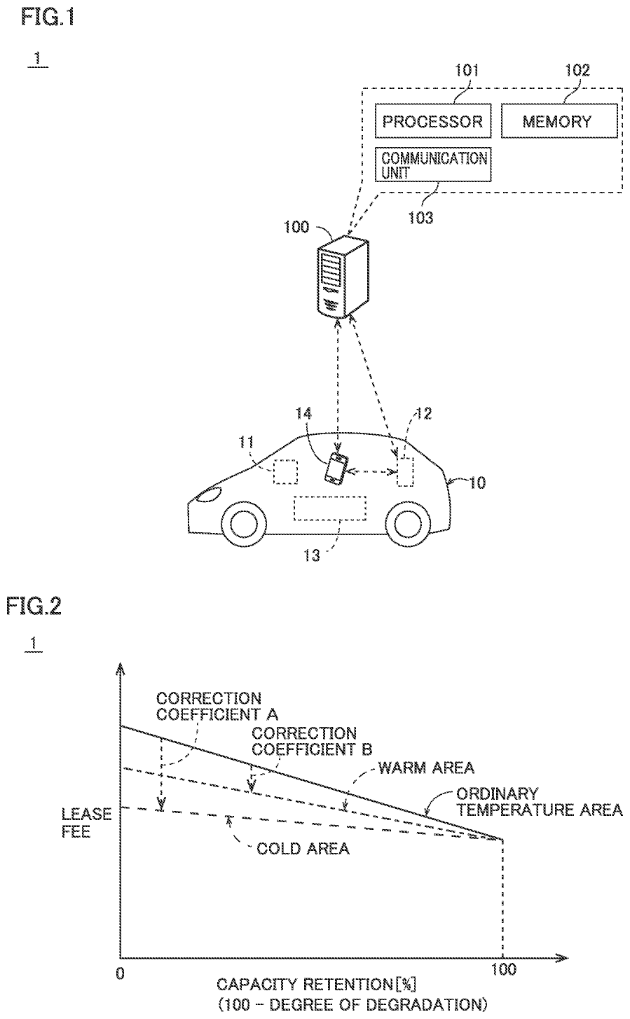

FIG. 1 is a diagram showing a configuration of a system 1 according to a first embodiment. The system 1 includes a server 100 and an electrically powered vehicle 10.

The electrically powered vehicle 10 includes, for example, PHEV (Plug-in Hybrid Electric Vehicle), BEV (Battery Electric Vehicle), and FCEV (Fuel Cell Electric Vehicle).

The electrically powered vehicle 10 includes a navigation system 11, a communication device 12, and a battery (secondary battery) 13. The battery 13 supplies power to electrical equipment such as the navigation system 11 and the communication device 12. The battery 13 is released from a management company of the battery 13 to a user of the electrically powered vehicle 10. The battery 13 is an example of the “secondary battery” of the present disclosure.

The user of the electrically powered vehicle 10 possesses the mobile terminal 14. The mobile terminal 14 is configured to be able to connect the communication device 12 with short-range wireless communication.

The communication device 12 may include DCM (Data Communication Module). The communication device 12 may include a 5G (fifth generation mobile communication system) compatible communication I/F.

The server 100 is configured to manage the registered information of the electrically powered vehicle 10 (hereinafter also referred to as “vehicle information”) and the registered information of the user (hereinafter also referred to as “user information”). The user information and the vehicle information are distinguished by identification information (ID) and stored in a memory 102 described later.

The user ID is identification information for identifying a user. The user ID also functions as information (terminal ID) for identifying the mobile terminal 14 carried by the user. The server 100 is configured to store information received from the mobile terminal 14 separately for each user ID. The user information includes a communication address of the mobile terminal 14 and a vehicle ID of the electrically powered vehicle 10.

The vehicle ID is identification information for identifying the electrically powered vehicle 10. The vehicle ID may be a number plate. The vehicle ID may be VIN (Vehicle Identification Number). The vehicle information includes an action schedule of the electrically powered vehicle 10.

The server 100 includes a processor (control unit) 101, a memory 102, and a communication unit 103. The processor 101 controls the communication unit 103. The processor 101 and the communication unit 103 are examples of the “control unit” and the “acquisition unit” of the present disclosure, respectively.

The memory 102 stores, in addition to a program executed by the processor 101, information (e.g., map, formula, and various parameters) used by the program.

The memory 102 stores information on the degree of degradation of the battery 13 of the electrically powered vehicle 10 (hereinafter referred to as degradation information). The degradation information includes information on the capacity retention (unit: %) of the battery 13. The degradation information stored in the memory 102 is updated every time new degradation information is received by the communication unit 103. Further, the degradation degree (100-capacity retention [%]) of the battery 13 may be used as the degradation information of the battery 13. The capacity retention of the battery 13 is an example of the “degree of degradation” of the present disclosure.

The capacity retention of the battery 13 means a ratio (percentage) of the full charge capacity C of the battery 13 at the present time with respect to the full charge capacity C0 of the battery 13 in the initial state (for example, the state at the time of manufacturing the battery 13) (Q=C/C0). However, as the degradation information of the battery 13, the EV travel distance (in km) of the electrically powered vehicle 10 may be used instead of or in addition to the capacity retention of the battery 13. As the degradation information of the battery 13, the full charge capacity (unit: Ah or Wh) itself of the battery 13 may be used. Further, any two or all three of the capacity retention, EV travel distance, and full charge capacity may be used.

The communication unit 103 of the server 100 communicates with each of the communication device 12 and the mobile terminal 14 of the electrically powered vehicle 10. The communication unit 103 receives degradation information of the battery 13 from the electrically powered vehicle 10 (communication device 12). The communication unit 103 may receive the degradation information from the mobile terminal 14.

Further, information for calculating the capacity retention of the battery 13 may be transmitted from the electrically powered vehicle 10 to the communication unit 103 of the server 100 without transmitting information on the capacity retention of the battery 13.

The processor 101 calculates the lease fee of the battery 13 based on the capacity retention of the battery 13.

Here, when the electrically powered vehicle 10 is normally used in an environment in which deterioration of the battery 13 tends to proceed, the battery 13 deteriorates more than normal. As a result, the lease fee of the battery 13 becomes higher than normal. Therefore, it is desirable to suppress an increase in the lease fee of the battery 13 due to the environment in which the electrically powered vehicle 10 is used.

In the first embodiment, the processor 101 performs suppression processing for suppressing an increase in the lease fee of the battery 13 based on a decrease in the capacity retention due to the environment in which the electrically powered vehicle 10 is used. The processor 101 suppresses the lease fee of the battery 13 used in cold or warm areas from being higher than the lease fee of the battery 13 used in ordinary-temperature (common-temperature) area.

Specifically, the processor 101 adjusts the correction coefficient for correcting the lease fee of the battery 13 according to the environment in which the electrically powered vehicle 10 is used. Thus, the suppression processing is performed.

As shown in FIG. 2, when the electrically powered vehicle 10 is normally used in a cold area, a correction coefficient A is used to calculate a lease fee. The correction coefficient A is a value less than 1. Specifically, by multiplying the lease fee corresponding to the capacity retention of the battery 13 of the electrically powered vehicle 10 normally used in the ordinary-temperature region by the correction coefficient A, the lease fee of the battery 13 of the electrically powered vehicle 10 normally used in the cold region is calculated. The correction coefficient A is set to increase as the capacity retention of the battery 13 decreases. The memory 102 stores data indicating the relationship between the correction coefficient A and the capacity retention of the battery 13. The correction coefficient A may be a constant value regardless of the magnitude of the capacity retention.

When the electrically powered vehicle 10 is normally used in a warm-up area, the correction coefficient B is used to calculate the lease fee. The correction coefficient B is smaller than the correction coefficient A and smaller than 1. Specifically, the lease fee of the battery 13 of the electrically powered vehicle 10 which is normally used in the warm-up area is calculated by multiplying the lease fee corresponding to the capacity retention of the electrically powered vehicle 10 which is normally used in the warm-up area by the correction coefficient B. The correction coefficient B is set to increase as the capacity retention of the battery 13 decreases. The memory 102 stores data indicating the relationship between the correction coefficient B and the capacity retention of the battery 13. The correction coefficient B may be a constant value regardless of the magnitude of the capacity retention.

Note that the correction coefficient A (B) may be set, for example, by a ratio between the degradation speed of the battery 13 in the ordinary-temperature region and the degradation speed of the battery 13 in the cold region (hot warm region). The magnitude relationship between the correction coefficients A and B is not limited to the above example. For example, the correction coefficient A may be equal to or greater than the correction coefficient B.

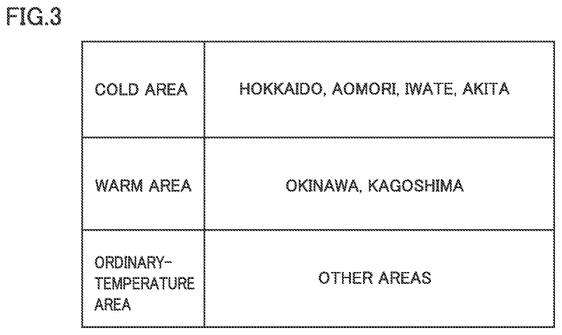

Further, as shown in FIG. 3, the memory 102 stores data indicating whether each area of Japan corresponds to an ordinary-temperature, cold, or warm area.

Specifically, the memory 102 stores data indicating that Hokkaido, Aomori prefecture, Iwate prefecture, and Akita prefecture are cold areas. The memory 102 stores data indicating that Okinawa prefecture and Kagoshima prefecture are warm area. The memory 102 stores data indicating that a region other than the above-described region is an ordinary-temperature area. Examples of the ordinary-temperature, cold, and warm areas are not limited to the above.

Further, the processor 101 specifies a region in which the electrically powered vehicle 10 is normally used based on the position information and the action history of the electrically powered vehicle 10. For example, the processor 101 extracts a region where the electrically powered vehicle 10 is located (or traveling) for the longest time based on the position information and the action history of the electrically powered vehicle 10. Then, the processor 101 identifies the extracted region as a region in which the electrically powered vehicle 10 is normally used. It should be noted that the method of specifying the usually-used area of the electrically powered vehicle 10 is not limited to the above example. For example, the processor 101 may identify the registered location of the electrically powered vehicle 10 (the location of the basis of use) or the address of the user as the area in which the electrically powered vehicle 10 is resident.

(Lease Price Method)

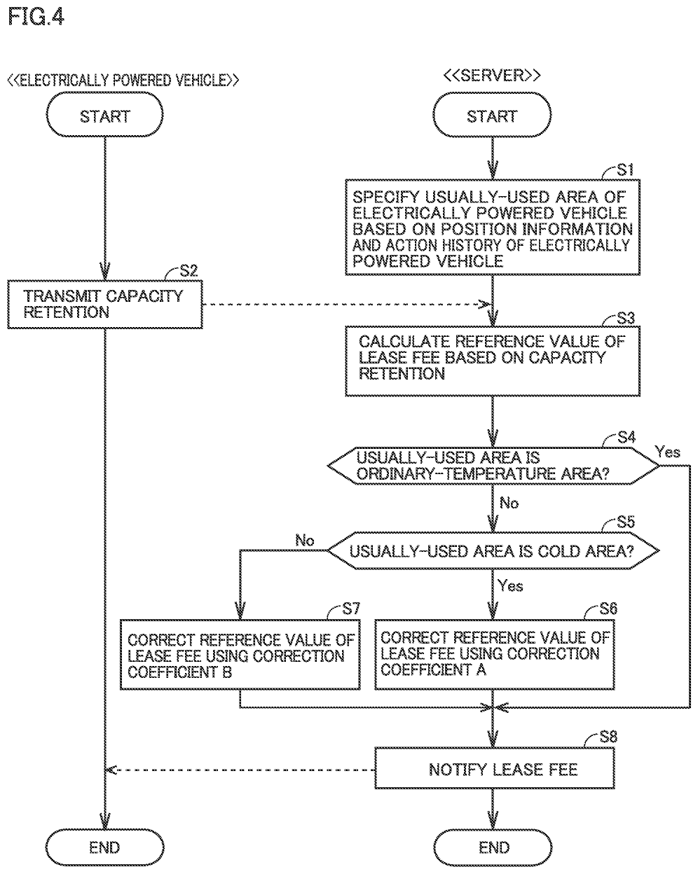

A method of calculating the lease fee of the battery 13 by the server 100 will be described with reference to the sequence diagram of FIG. 4.

In step S1, the server 100 (processor 101) specifies a region in which the electrically powered vehicle 10 is usually used based on the position information and the action history of the electrically powered vehicle 10.

In step S2, the electrically powered vehicle 10 transmits information on the capacity retention of the battery 13 to the server 100. The above-described processing is executed at a predetermined cycle. In addition, the server 100 may acquire information of the capacity retention of the battery 13 from the mobile terminal 14, a server that manages the capacity retention, or the like.

In step S3, the processor 101 calculates a reference value of the lease fee of the battery 13 based on the capacity retention of the battery 13 transmitted from the electrically powered vehicle 10 in step S2. The reference value of the lease fee means a lease fee corresponding to the capacity retention when it is assumed that the normal area of the electrically powered vehicle 10 is an ordinary-temperature area.

In step S4, the processor 101 determines whether or not the usually-used area of the electrically powered vehicle 10 identified in step S1 is an ordinary-temperature area. When the area is an ordinary-temperature area (Yes in S4), the process proceeds to step S8. When the usually-used area is not a ordinary-temperature area (No in S4), the process proceeds to step S5.

In step S5, the processor 101 determines whether or not the usually-used area is a cold place. When the usually-used area is cold (Yes in S5), the process proceeds to step S6. When the usually-used area is not a cold place but a warm place (No in S5), the process proceeds to step S7.

In step S6, the processor 101 corrects the reference value of the lease fee calculated in step S3 using the correction coefficient A. Specifically, the processor 101 corrects the reference value using the correction coefficient A corresponding to the capacity retention of the battery 13 acquired in the processing of step S2.

In step S7, the processor 101 corrects the reference value of the lease fee calculated in step S3 using the correction coefficient B. Specifically, the processor 101 corrects the reference value using the correction coefficient B corresponding to the capacity retention of the battery 13 acquired in the processing of step S2.

In step S8, the processor 101 notifies the user of the electrically powered vehicle 10 of the lease fee of the battery 13 through the communication unit 103. More specifically, when the normal area of the electrically powered vehicle 10 is the ordinary-temperature area, the reference value of the lease fee calculated in step S3 is notified. When the usually-used area of the electrically powered vehicle 10 is cold place, the calculated (corrected) lease fee is notified in step S6. When the usually-used area of the electrically powered vehicle 10 is a warm place, the calculated (corrected) lease fee is notified in step S7.

As described above, in the first embodiment, the processor 101 performs suppression processing for suppressing an increase in lease fee based on deterioration of the degree of degradation (capacity retention) of the battery 13 due to the environment in which the electrically powered vehicle 10 is used. Thus, when the electrically powered vehicle 10 is used in a severe environment for the battery 13, it is possible to suppress an increase in lease fee due to deterioration of the battery 13. As a result, it is possible to suppress a difference in satisfaction with respect to lease fee between users in different areas.

### Second Embodiment

Next, the server 200 and the system 2 according to the second embodiment will be described with reference to FIGS. 5 to 7. Unlike the first embodiment in which the correction coefficient for correcting the lease fee is adjusted according to the use environment of the electrically powered vehicle 10, the second embodiment ignores a variation in the degree of degradation of the battery 13 due to a difference in environment. The same components as those in the first embodiment are denoted by the same reference numerals as those in the first embodiment, and a repetitive description thereof will not be given.

FIG. 5 is a diagram showing a configuration of a system 2 according to a second embodiment. The system 2 includes a server 200 and an electrically powered vehicle 10.

The server 200 includes a processor 201, a memory 202, and a communication unit 203. The processor 201 controls the communication unit 203. The processor 201 and the communication unit 203 are examples of the “control unit” and the “acquisition unit” of the present disclosure, respectively.

In the second embodiment, the processor 201 calculates the lease fee of the battery 13 by ignoring deterioration of the degree of degradation (capacity retention) of the battery 13 due to the environment in which the electrically powered vehicle 10 is used.

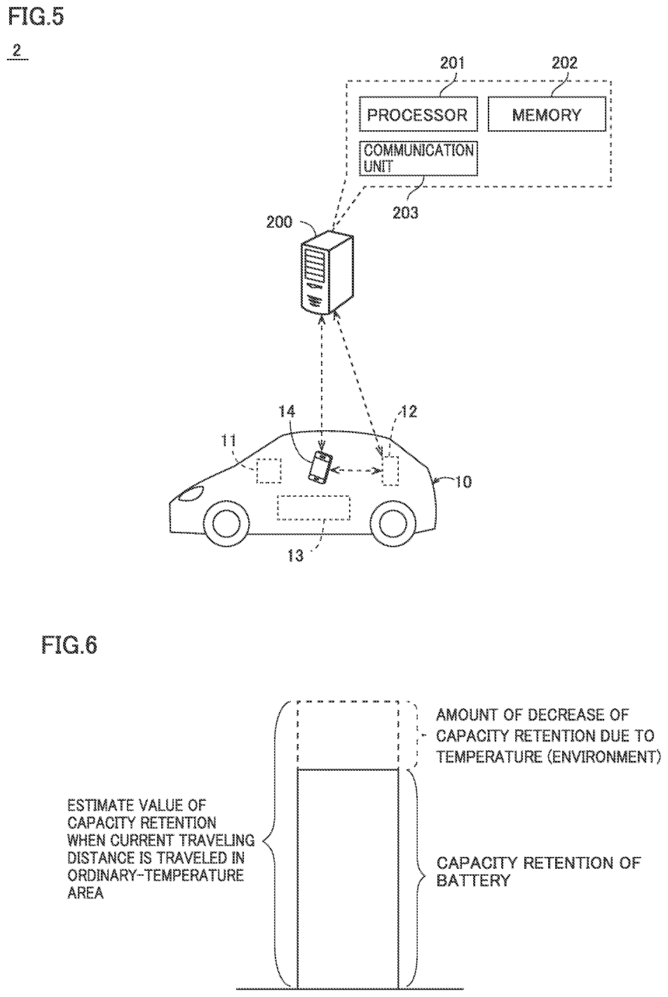

As shown in FIG. 6, the degree of degradation of the battery 13 includes factors based on the environment (air temperature) in which the electrically powered vehicle 10 is used. As a result, the capacity retention of the battery 13 in the case where the electrically powered vehicle 10 is normally used in the cold area or the warm area is lower than in the case where the electrically powered vehicle 10 is normally used in the ordinary-temperature area.

Therefore, the processor 101 estimates the capacity retention when the current traveling distance of the electrically powered vehicle 10 is traveled in the ordinary-temperature region. Then, the processor 101 calculates the lease fee of the battery 13 based on the estimated capacity retention.

(Lease Price Method)

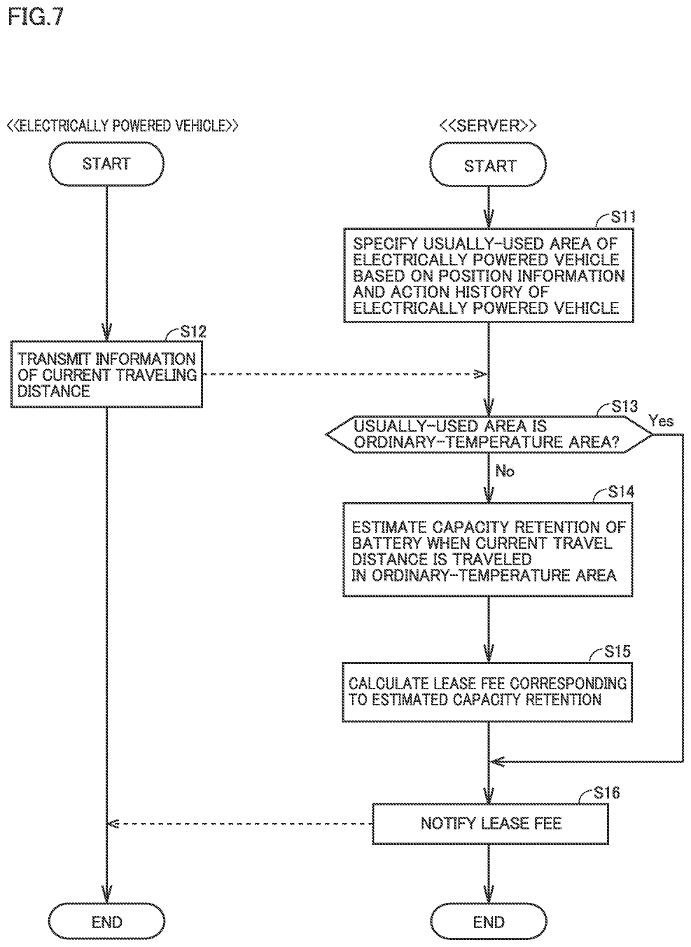

A method of calculating the lease fee of the battery 13 by the server 200 will be described with reference to the sequence diagram of FIG. 7.

In step S11, the server 200 (processor 201) specifies a region in which the electrically powered vehicle 10 is normally used based on the position information and the action history of the electrically powered vehicle 10.

In step S12, the electrically powered vehicle 10 transmits information on the travel distance of the battery 13 to the server 200. The above-described processing is executed at a predetermined cycle. In addition, the server 200 may acquire information on the traveling distance of the electrically powered vehicle 10 from the mobile terminal 14, a server that manages the traveling distance, or the like.

In step S13, the processor 201 determines whether or not the usually-used area of the electrically powered vehicle 10 identified in step S11 is an ordinary-temperature place. When the area is an ordinary-temperature area (Yes in S13), the process proceeds to step S16. When it is determined that the normal area is not an ordinary-temperature area but a cold area or a warm area (No in S13), the process proceeds to step S14.

In step S14, the processor 201 estimates the capacity retention of the battery 13 based on the travel distance of the electrically powered vehicle 10 acquired in the process of step S12. Specifically, the processor 201 estimates the capacity retention of the battery 13 by referring to the relationship between the travel distance of the plurality of other electrically powered vehicles normally used in the ordinary-temperature region and the capacity retention of the battery 13. A table indicating the relationship between the traveling distance of the electrically powered vehicle and the battery capacity retention may be stored in the memory 202.

In step S15, the processor 201 calculates a lease fee of the battery 13 corresponding to the capacity retention of the battery 13 estimated in step S14.

That is, the processor 201 calculates the lease fee of the battery 13 based on the travel distance of the electrically powered vehicle 10, regardless of the degree of degradation of the battery 13 due to the temperature in the cold or warm area.

In step S16, the processor 201 notifies the user of the electrically powered vehicle 10 of the lease fee of the battery 13 through the communication unit 203.

Other configurations of the second embodiment are similar to those of the first embodiment, and therefore, repetitive description thereof will not be given.

In the first embodiment, the lease fee of the battery 13 is multiplied by the correction coefficient. The capacity retention of the battery 13 may be corrected based on a predetermined correction coefficient. In this case, the lease fee of the battery 13 is calculated based on the corrected capacity retention of the battery 13. As a result, the lease fee of the battery 13 is corrected based on the predetermined correction coefficient.

In the second embodiment, the lease fee of the battery 13 is calculated based on the travel distance of the electrically powered vehicle 10. In addition to (or instead of) the travel distance of the electrically powered vehicle 10, the lease fee of the battery 13 may be calculated based on the use period of the battery 13 (for example, the elapsed time from the time of manufacturing the battery 13).

In the first embodiment, one of the correction coefficients A and B to be used is used based on the usually-used area of the electrically powered vehicle 10, but the present disclosure is not limited thereto. When the electrically powered vehicle 10 is used in a plurality of regions, the correction coefficient may be adjusted based on the ratio of the stay time in each region.

In the above-described first and second embodiments, an example is shown in which cold areas, warm areas, and ordinary-temperature areas are set for each prefecture, but the present disclosure is not limited thereto. For example, the above setting may be performed based on the average temperature of the past predetermined period in each region. It should be noted that the above setting may also be performed for areas other than Japan.

In the first embodiment, an example in which the lease fee is corrected in the case where the normal area of the electrically powered vehicle 10 is the cold area or the warm area is shown, but the present disclosure is not limited thereto. The lease fee may be corrected when the normal use area of the electrically powered vehicle 10 is either a cold area or a warm area.

In the above-described first and second embodiments, an example is shown in which the processing of suppressing the increase of the lease fee is performed based on the temperature difference between the regions, but the present disclosure is not limited thereto. For example, the above-described processing may be performed based on a difference in the amount of water drop, the amount of snow drop, the humidity, and the like between each region.

The configurations (processing) of the above-described embodiments and the above-described modified examples may be combined with each other.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A server that calculates a lease fee of a secondary battery leased to an electrically powered vehicle, the server comprising:
an acquisition unit that acquires information of a degree of degradation of the secondary battery; and
a control unit that calculates the lease fee using the information of the degree of degradation, wherein
the control unit performs suppression processing for suppressing an increase of the lease fee, the increase of the lease fee being based on deterioration of the degree of degradation due to an environment in which the electrically powered vehicle is used.

2. The server according to claim 1, wherein the control unit performs the suppression processing by adjusting, in accordance with the environment, a correction coefficient for correcting the lease fee.

3. The server according to claim 1, wherein the control unit performs the suppression processing by calculating the lease fee while ignoring the deterioration of the degree of degradation due to the environment.

4. The server according to claim 1, wherein the control unit performs the suppression processing when the control unit determines that the electrically powered vehicle is usually used in a cold area.

5. A lease fee calculation method for calculating a lease fee of a secondary battery leased to an electrically powered vehicle, the lease fee calculation method comprising:
acquiring information of a degree of degradation of the secondary battery; and
calculating the lease fee using the information of the degree of degradation,
wherein
the calculating includes suppressing an increase of the lease fee, the increase of the lease fee being based on deterioration of an environment in which the electrically powered vehicle is used.
